(19) United States
(12) Patent Application Publication
(10) Pub. No.: US 2024/0352049 A1
(43) Pub. Date: Oct. 24, 2024

(54) DIRECT SYNTHESIS OF ALKOXYSILANES USING COPPER-ALUMINUM ALLOY CATALYSTS

(71) Applicant: Momentive Performance Materials Inc.

(72) Inventors: Kenrick Martin Lewis, Flushing, NY (US); Abellard Mereigh, Yonkers, NY (US)

(21) Appl. No.: 18/632,442

(22) Filed: Apr. 11, 2024

Related U.S. Application Data
(60) Provisional application No. 63/460,488, filed on Apr. 19, 2023.

(51) Int. Cl. C07F 7/18; B01J 23/72; B01J 35/45

(52) U.S. Cl. CPC C07F 7/1872; B01J 23/72; B01J 35/45

(57) ABSTRACT

An improved catalyzed reaction of silicon metal with alcohol is provided for the formation of alkoxysilanes, particularly trialkoxysilanes. The Direct Synthesis reaction of silicon metal and alcohol employs a catalytically effective amount of a copper-aluminum alloy as a catalyst precursor and further benefits from an effective catalyst-promoting amount of a catalyst promoter.

### CROSS REFERENCE TO RELATED APPLICATIONS

This application claims the benefit of and priority to Provisional Application Ser. No. 63/460,488, filed Apr. 19, 2023, the entire contents of which are incorporated herein by reference.

### FIELD OF THE INVENTION

This invention relates to the Direct Synthesis of alkoxysilanes by the copper catalyzed reaction of silicon metal with alcohols.

### BACKGROUND OF THE INVENTION

Trialkoxysilanes, especially trimethoxysilane, triethoxysilane and tri (isopropoxy) silane, are used in the production of silane coupling agents. One method of synthesis of trialkoxysilanes is directly from silicon metal and an alcohol in the presence of copper or a copper compound. This method is known variously in the art as the Direct Synthesis, the Direct Reaction, the Direct Process or the Rochow Reaction. For trialkoxysilanes, it is most conveniently performed in slurry reactors.

Copper sources to be used as catalysts in the Direct Synthesis of trialkoxysilanes are desirably anhydrous and free of corrosive agents such as chloride ions. A wide variety of copper containing catalysts useful in the Direct Synthesis of alkoxysilanes has been disclosed in the literature, but none of these has been found to be fully satisfactory in achieving desired selectivity, reaction rate and stability. For example, U.S. Pat. No. 5,362,897 discloses a Direct Process for producing trialkoxysilanes in which reaction is effected with the use of “wet process” CuCl, in preference to commercial “dry process” CuCl, silicon containing 0.30-0.37 weight percent aluminum and the coexistence of aluminum or an aluminum compound to obtain high reaction rates and silicon conversions. “Wet process” CuCl is defined (column 2, lines 51-54) as that “prepared through the steps of crystallization and separation and drying. Dry process CuCl is prepared from metallic copper and chlorine gas (Column 2, lines 62-65). The specifications further disclose (Column 3, lines 46-48) that aluminum alloys of Si, Ca and Mg are suitable and that the aluminum alloys used must contain more than fifty weight percent (>50 wt %) Al.

Considering the state-of-the-art of the Direct Synthesis of alkoxysilanes, it is apparent that there remains an ongoing need for improved processes having desirably high reaction rates, selectivity and silicon conversions in the Direct Synthesis of alkoxysilanes, with reduced production of unwanted byproducts and which overcome other drawbacks of conventional processes.

### SUMMARY OF THE INVENTION

Generally, in accordance with the invention, an improved catalyzed reaction of silicon metal with alcohols is provided for the formation of alkoxysilanes, particularly trialkoxysilanes. The Direct Synthesis reaction of silicon metal and alcohol in accordance with preferred embodiments of the present invention employs a catalytically effective amount of a copper-aluminum alloy as a catalyst precursor and, optionally, further benefits from an effective catalyst-promoting amount of a catalyst promoter, said promoter being an organic or inorganic compound possessing at least one phosphorus-oxygen bond if trimethoxysilane is the desired trialkoxysilane, and copper (I) cyanide and/or an organonitrile when triethoxysilane is the target product. These copper-aluminum alloys can promote selectivity to trialkoxysilanes, control formation of tetraalkoxysilanes and/or improve reaction stability in batchwise, semi-continuous or continuous operations.

One aspect of the invention provides a Direct Synthesis process for producing alkoxysilanes, especially trialkoxysilanes, from silicon metal and alcohols, such as methanol, ethanol and higher alcohols, with reduced co-production of tetraalkoxysilane. These advantages are demonstrated with the use of copper-aluminum (Cu—Al) alloys as the source of copper for the catalytic activation of silicon metal.

Another aspect of the invention provides an improved Direct Synthesis process comprising the use of an anhydrous, non-halide copper-aluminum alloy as the catalyst precursor to obtain desirable reaction rates and selectivities and high silicon conversion rates. These alloys preferably contain less than fifty weight percent (<50 wt %) aluminum to obtain the desirable reaction rates and selectivities and high silicon conversions.

It has been determined that water reacts with trialkoxysilanes and tetraalkoxysilanes to produce soluble, gelled and/or resinous organic silicates. Formation of these silicates represents inefficiency in the Direct Synthesis process. Additionally, the silicates contribute to undesirable foaming and incomplete recovery of the reaction solvent, as disclosed in U.S. Pat. Nos. 5,783,720 and 6,090,965, which are incorporated by reference in their entireties herein. Therefore, a further aspect of the invention employs anhydrous catalyst precursors and those which do not produce water during thermal decomposition.

A further aspect of the invention provides the Direct Synthesis of trialkoxysilanes, in which formation of condensed silicates, gels and resins is prevented or substantially reduced.

In view of the foregoing, the invention provides for the production of trialkoxysilane with significantly reduced levels of tetraalkoxysilane by-product while providing, inter alia, selected reaction rates at desirable values, avoiding or reducing deactivation, reducing formation of condensed silicates, gels and resins, increasing silicon conversion and maintaining selectivity at high levels, particularly in continuous and semi-continuous operations.

In a preferred embodiment, the invention provides a process for the Direct Synthesis of alkoxysilanes comprising: (a) forming a reaction slurry comprising a thermally stable solvent, silicon metal, a catalytically effective amount of Cu—Al catalyst precursor, and optionally a catalyst promoter; (b) agitating and heating the reaction slurry to form copper-activated silicon in-situ and feeding an alcohol into said reaction slurry to react with said copper activated-silicon to produce the alkoxysilanes; and, optionally, (c) recovering the alkoxysilanes.

### DETAILED DESCRIPTION OF THE PREFERRED EMBODIMENTS

The present invention relates to the synthesis of alkoxysilanes from silicon metal and alcohol. The process whereby silicon metal and alcohol are converted into alkoxysilanes, such as trialkoxysilane and co-products involves physical and chemical phenomena occurring both simultaneously and sequentially. Adequate chemical activity (reaction rate) and selectivity over a certain time period (duration of conversion) are necessary to fulfill specified economic and process engineering requirements. If activity and selectivity decline sharply after attaining desirable values and thereby limit the conversion of raw materials to trialkoxysilanes, then the process is inefficient and unstable. Stability is the maintenance of desirable rate and selectivity until all raw materials are consumed, or consumed beyond a preset criterion. Thus, a steady-state period during which rate and selectivity plateau and are relatively constant contributes to effective process control and efficient raw material utilization.

Unless defined otherwise, all technical and scientific terms used herein will have the same meaning as commonly understood by one of ordinary skill in the art to which this invention belongs. Generally, the nomenclature used herein and the laboratory procedures described are well known and commonly employed in the art. Where a term is provided in the singular, the inventors also contemplate that the plural of that term is also applicable. “Direct Process,” “Direct Synthesis,” and “Direct Reaction” refer to a Rochow and Richard Müller process, the most common technology for preparing organosilicon compounds on an industrial scale. It involves the copper-catalyzed reaction of alkyl halides with silicon metal, and generally takes place in a fluidized bed reactor.

In a slurry reactor for the Direct Synthesis of trialkoxysilanes, catalytically activated silicon particles are maintained in suspension in a thermally stable, high boiling solvent and are made to react with an alcohol at an elevated temperature. The product stream exiting the reaction zone typically comprises a mixture of unreacted alcohol, trialkoxysilane, tetraalkoxysilane, alkyldialkoxysilane, alkyltrialkoxysilane and condensed silicates. Trialkoxysilane is usually the desired product. It is desirable to improve the production of the most desirable products of known synthesis methods.

Selectivity can be calculated as the preference for the formation of trialkoxysilane under the reaction conditions. It is expressed herein as the gravimetric ratio trialkoxysilane/tetraalkoxysilane. Alternatively, selectivity can be expressed as mole percentage, i.e., 100 moles trialkoxysilane/molar sum of all silicon-containing products. It is desirable to improve the selectivity of known synthesis methods.

The rate of the Direct Synthesis of a trialkoxysilane can be calculated as the temporal consumption of the raw materials, i.e., alcohol or silicon metal, or the temporal formation of products, e.g., trialkoxysilane, or optionally including by-products. The reaction rate units are commonly weight percent silicon conversion per hour, e.g., kilograms product per kilogram silicon metal consumed per hour. It is desirable to improve the reaction rates of known synthesis methods.

Stability can be considered the maintenance of the desirable rate and selectivity until all raw materials are consumed, or consumed beyond a preset criterion. The progress of the Direct Synthesis can be monitored by determining product composition and/or reaction rate as a function of time or silicon metal conversion. In a batchwise operation, the reaction profile typically shows an initial period (referred to as the induction period) of increasing rate and increasing trialkoxysilane concentration in the reaction mixture, after which the reaction settles into a steady state. In this state, the composition of the reaction mixture remains approximately constant. A period of declining rate and decreasing trialkoxysilane content in the product mixture typically follows the steady state. It is desirable to improve the stability of known synthesis methods.

It is believed that the actual catalysts in the Direct Synthesis of alkoxysilanes are the copper-silicon alloys or intermetallics and solid solutions, formed by the diffusion of copper into silicon metal, or by the reaction of copper compounds with silicon metal. Thus, the copper-containing raw materials effective in activating silicon for the Direct Synthesis with alcohols should all be considered catalyst precursors and will be referred to herein as such.

The following equations are representations of the principal chemical reactions occurring during the Direct Synthesis of trialkoxysilanes with alcohols (ROH):

$$Si + 3 ROH \to {HSi ( OR )}_{3} + {H}_{2} \qquad ( 1 )$$

$${HSi ( OR )}_{3} + ROH \to {Si ( OR )}_{4} + {H}_{2} \qquad ( 2 )$$

$$ROH + {H}_{2} \to RH + {H}_{2} O \qquad ( 3 )$$

$$2 ROH \to ROR + {H}_{2} O \qquad ( 4 )$$

$${RCH}_{2} OH \to {R}^{′} CH = {CH}_{2} + {H}_{2} O \qquad ( 5 )$$

$$2 {Si ( OR )}_{4} + {H}_{2} O \to {( RO )}_{3} {SiOSi ( OR )}_{3} + 2 ROH \qquad ( 6 )$$

$$2 {HSi ( OR )}_{3} + {H}_{2} O \to {H ( RO )}_{2} {SiOSi ( OR )}_{2} H + 2 ROH \qquad ( 7 )$$

$$2 {HSi ( OR )}_{3} + {Si ( OR )}_{4} + {H}_{2} O \to {HSi ( RO )}_{2} {SiOSi ( OR )}_{2} {OSi ( OR )}_{2} H + 2 ROH \qquad ( 8 )$$

$${RCH}_{2} OH \to RCHO + {H}_{2} \qquad ( 9 )$$

$$RCHO + 2 {RCH}_{2} OH \to {RCH ( {OCH}_{2} R )}_{2} + {H}_{2} O \qquad ( 10 )$$

$${RR}^{″} CHOH \to {RR}^{″} CO + {H}_{2} \qquad ( 11 )$$

The desirable products of the instant Direct Synthesis are alkoxysilanes, particularly trialkoxysilanes of general formula HSi(OR)₃, and alkyldialkoxysilanes of general formula, RSiH(OR)₂, wherein R is an alkyl group of from 1 to 6 carbon atoms. R is preferably methyl, ethyl, propyl or isopropyl. By-products of the synthesis include Si(OR)₄, RSi(OR)₃, linear, branched and cyclic silicates such as (RO)3SiOSi(OR)3, H(RO)2SiOSi(OR)2H, HSi(RO)2SiOSi(OR)3, (RO)3SiOSi(OR)2R, (RO)3SiOSi(RO)2OSi(RO)3, (RO)3SiOSi(OR) HOSi(OR)3, (RO)3SiOSi(OR) ROSi(OR)3, (RO)Si[OSi(OR)3]3, (RO)3SiOSi(OR)(OSi(RO)3)OSi(OR)3, [OSi(OR)2] n, wherein n is at least 4 and in which R is as previously defined, hydrogen gas, hydrocarbons such as methane and ethane, alkenes such as ethylene, ethers such as dimethyl ether and diethyl ether, aldehydes such as acetaldehyde, acetals such as 1,1-diethoxyethane and ketones such as acetone.

Hydrogen gas, hydrocarbons, volatile aldehydes, ketones and the ethers are typically not recovered with the liquid reaction products, but exit the reaction apparatus vessel as a gaseous stream. Some of the silicates are volatilized out of the reactor and are soluble in the liquid reaction product. Others remain solubilized in the solvent or precipitate as insoluble gels and resins. Linear, branched and cyclic silicates, gels and resins are formed via hydrolysis and condensation of trialkoxysilanes and tetraalkoxysilanes.

It is important that water generation (see Equations 4, 5 and 10) be prevented or minimized. For example, water will react with trialkoxysilanes and tetraalkoxysilanes to produce soluble, gelled and/or resinous organic silicates. Formation of these silicates represents inefficiency in the Direct Synthesis process. The acetals and less volatile aldehydes and ketones are present in the liquid reaction mixture.

In addition to the alkoxysilanes, the gaseous product stream can contain hydrogen gas, hydrocarbons, ethers, volatile aldehydes and ketones and inerting agents such as nitrogen or argon. Analytical methods based on gas chromatography, Fourier Transform Infra-red spectroscopy (FTIR) or mass spectrometry can be used to identify and quantify these components in the gaseous effluent. Assuming that the reaction of equation [1] produces most of the hydrogen gas in the effluent, the amount of hydrogen generated in the Direct Synthesis can be used as an approximate measure of reaction rate and silicon conversion. Hydrocarbon and ether formation depicted in equations [3-5] and aldehyde, acetal and ketone formation in equations [9-11] can be used as measures of the inefficiency of alcohol conversion. It is desirable that less than 2 weight percent of the alcohol fed to the reaction be converted to hydrocarbons, ethers, aldehydes, acetals and ketones and most desirable that none be so converted.

Gas chromatographic (GC) analysis has been found to be a reliable and accurate technique to quantify the composition of the liquid reaction product. Other methods, such as nuclear magnetic resonance (NMR) and mass spectrometry (MS) can also be used. These are particularly useful for identifying and quantifying the higher molecular weight silicates contained in the reaction product and reaction solvent. Data on the composition and weight of the reaction product and the fraction of silicon in each of the components are used to calculate the silicon conversion.

Gravimetry, atomic absorption spectroscopy and inductively coupled plasma (ICP) spectrometry are suitable methods for quantifying the silicon content of the reaction solvent. Suitable analytical procedures include those given in The Analytical Chemistry of Silicones, Chapter 8, A. L. Smith, Ed., Wiley & Sons Inc., NY, 1991. Soluble silicates retained in the reaction solvent are a measure of the extent to which side reactions such as those in equations 6-8 have occurred. All of these reactions depend on the presence of water, which is formed, for example, by the reaction of equations 3-5 and 10. Gels and soluble silicates contained in the reaction solvent can be removed according to the methods disclosed in U.S. Pat. Nos. 5,166,384; 6,090,965 and 6,166,237. The contents of these patents and references, as well as those identified above and below, are incorporated herein by reference, in their entirety.

Reactions can be run in a batchwise, semi-continuous or continuous mode. In batchwise operation, a single addition of silicon metal, copper catalyst precursor and promoter is made to the reactor at the outset and alcohol is added continuously or intermittently, until the silicon metal is fully reacted, or reacted to a desired degree of conversion. In continuous operation, silicon metal, copper catalyst precursor and promoter are added to the reactor initially and thereafter to maintain the solids content of the slurry within desired limits. The batchwise mode is illustrated in U.S. Pat. No. 4,727,173 and a continuous mode in U.S. Pat. No. 5,084,590.

In semi-continuous mode, additional silicon metal, copper catalyst precursor and promoter are introduced to the reactor during, or on completion of, a batchwise reaction. Thereby, multiple silicon, copper catalyst and promoter additions are made to a single charge of solvent (see Examples 6 and 7 of U.S. Pat. No. 4,727,173). Additions are typically made towards the end of the steady-state period of each charge. If the copper source is hydrated, or generates water during thermal decomposition, alcohol flow is usually interrupted while additions are made. After a number of such additions, the tetraalkoxysilane content of the crude product typically increases to greater than about 6 weight percent and even to as high as about 12 weight percent. Owing to the accumulation of condensed silicates in the solvent, its viscosity and foamability both generally increase.

If a hydrated copper catalyst precursor is used, provision should be made in the design of the reaction system to avoid contact of any water formed during its dehydration and thermal decomposition with the trialkoxysilane reaction product. Additionally, introduction of the reactant into the reaction slurry should be delayed until the dehydration and thermal decomposition are complete. This can be achieved at temperatures greater than 150° C., preferably 150-180° C., at ambient pressure. The advantages of the invention can be achieved with a catalytically effective halide-free, anhydrous copper source that does not generate water in the reactor and also facilitates continuous Direct Synthesis of trialkoxysilanes.

It is desirable that tetraalkoxysilane content remain less than about 6 weight percent through the completion of at least three silicon metal additions, and preferably through at least six additions. It is also desirable to make additions of silicon metal, copper catalyst precursor and promoter to the reaction without interrupting the alcohol flow. Both of these desirable objectives can be realized with practices comprising the use of the copper-aluminum alloys as copper catalyst precursors. These alloys should be halide-free and anhydrous.

When the Direct Synthesis is conducted with copper-aluminum alloys pursuant to the present invention, trialkoxysilanes generally comprise at least about 70 weight percent, preferably at least about 80 weight percent, of the liquid reaction products. Typical levels of the tetraalkoxysilanes, Si(OR)4, are less than 7 weight percent and preferably less than about 6 weight percent. (RO)2SiH2, RSiH(OR)2 and RSi(OR)3 compounds are individually less than about 4 weight percent and preferably less than about 2 weight percent. Condensed silicates are maximally about 5 weight percent and preferably less than about 1 weight percent.

In addition to the foregoing percentage ranges, selectivity to the desired trialkoxysilanes can also be expressed as the gravimetric ratio, HSi(OR)3/Si(OR)4. By the process of this invention, this ratio is at least about 16 when computed over the total course of a reaction. This overall value is also referred to herein as the product selectivity, to distinguish it from the selectivity of individual samples taken during the course of a reaction. It is preferably at least about 18 and can attain values greater than 30 during the steady-state phase of the reaction.

Reaction rate is typically expressed as silicon metal conversion per unit time, but it can also be expressed as alcohol conversion per unit time or as space time yield (product output per unit weight of raw material per unit time). It is desirable to have reaction rates which provide a good balance between product formation and heat removal (temperature control) from the reactor. Rates greater than about 4 weight percent silicon conversion per hour, preferably from about 5-20 percent silicon conversion per hour can be obtained with the process of this invention. It is also achievable that the induction time, i.e., the interval between the onset of reaction and the attainment of both steady-state rate and product composition, be brief, preferably less than about 4 hours and more preferably less than about 1 hour. During that time, the maximum amount of silicon metal consumed will ordinarily be about 15 weight percent and advantageously will be less than about 10 weight percent.

Reaction stability is the maintenance of desirable rate and selectivity until all of the silicon metal is consumed or is consumed to a predetermined criterion. Thus, the extent of silicon conversion is a quantitative measure of reaction stability. Silicon conversions greater than about 70 weight percent, advantageously greater than about 85 weight percent and better yet, greater than about 90 weight percent can be reliably achieved by the process of this invention.

The present invention also includes the use of organic and inorganic phosphates to obtain Si(OR)4 reaction profiles (plot of concentration of Si(OR)4 in product mixture versus reaction time, alcohol fed or silicon conversion) that remain at minimal values for longer periods compared with controls. When ethanol is the reactant, copper (I) cyanide (CuCN) and/or organonitriles are advantageously used to improve reaction stability. Use of organic and inorganic phosphates as promoters is disclosed in U.S. Pat. No. 7,652,164. Use of CuCN and/or organonitriles is disclosed in U.S. Pat. No. 7,429,672.

### Copper-Aluminum Alloy Catalyst Precursors

Without wishing to be bound by theory, the copper-aluminum alloys useful as starting materials to activate silicon metal for Direct Reactions with an alcohol are not themselves believed to be the actual catalysts for the Direct Synthesis process. When a slurry comprising a copper-aluminum alloy, silicon metal and a thermally stable reaction solvent is heated, the copper and silicon interact to produce what is believed to be the actual catalytic phase that reacts with the alcohol. It is believed that the actual catalysts are copper-silicon intermetallics and/or solid solutions formed by the diffusion of copper into silicon, or by the reaction of copper compounds with silicon metal. Thus, the copper-aluminum alloy raw materials are copper catalyst precursors and will be so described herein.

Copper-Aluminum alloys of this invention are binary compositions, but trace amounts of other metals that do not impair or inhibit the Direct Process may be present. Cu—Al alloy compositions comprise those containing from about 4 weight percent copper to about 4 weight percent aluminum. The preferred composition range is from about 20 weight percent copper to about 85 weight percent copper, i.e., 80 to 15 percent aluminum. More preferred are alloys in the composition range 33 to 80 weight percent copper. Particularly effective Cu—Al alloys contain less than 50% aluminum, preferably about 15 to 50 percent aluminum and more preferably about 35-45% aluminum, with the balance copper.

The Cu—Al alloy catalyst precursors are advantageously employed as powders. The powders can contain Al—Cu solid solutions and stoichiometric ordered Al—Cu phases such as Al2Cu, Al3Cu4 and Al4Cu9 as are disclosed in Zobac, et al., METALLURGICAL AND MATERIALS TRANSACTIONS A 50 (2019) pp 3805-3815). Composition of the copper-aluminum alloys can be determined by wet chemical analysis, Atomic Absorption, Inductively Coupled Plasma (ICP) spectroscopy, Energy Dispersive X-Ray (EDX) analysis, or equivalent methods. Bulk structure can be established by XRD (X-Ray Diffraction). If the surface composition of the copper-aluminum alloys is of interest, then X-Ray Photoelectron Spectroscopy (XPS) can be employed.

Copper-Aluminum catalyst precursors with a particle size distribution ranging from about 0.1 to about 100 micrometers, preferably about 0.1 to about 50 micrometers, are effective in the process of the instant invention. However, nanosized precursors can be even more effective. Nanometer sized particles have particle size distributions in the range of from about 1 nanometer (10-9 meter) to about 100 nanometers (10-7 meter). Especially preferred are catalyst precursor particles with particle size distributions in the 20 to 60 nanometer range. These nanosized materials are also described in the art as nanostructured, nanocrystalline, nanosized, nanoscale, ultrafine or superfine. Their structures and high surface-to-volume ratios make them especially desirable in catalytic, electronic, magnetic and coating (pigment) applications. When compared with the conventional copper catalysts precursors for the Direct Synthesis of trialkoxysilanes, nanometer sized particles are 10 to 100 fold smaller.

Nanosized copper sources are particularly advantageous for use herein. In an embodiment of the invention, the nanosized precursors have particle size distributions of from about 0.1 to about 600 nanometers. In a second embodiment, the particle size distributions will range from about 0.1 to about 500 nanometers; and in a third embodiment, from about 0.1 to about 100 nanometers. Particle sizes can be determined by Transmission Electron Microscopy (TEM), High Resolution Scanning Electron Microscopy (HRSEM), or equivalent methods.

Various physical and chemical methods are known in the art for the preparation of nanosized copper-aluminum alloys. They include high energy milling (see Yadav, et al., Nanoscience and Nanotechnology 2 (2012) pp 22-48), laser ablation (see N. Patra, et al., IOP Conf. Ser.: Mater. Sci. Eng. 390 (2018) 012046) and electric explosion (see N. V. Svarovskaya, et al., Progress in Natural Science: Materials International, 25 (2015) pp 1-5).

Copper-aluminum catalyst precursors for use in the present invention are advantageously anhydrous, but material containing adventitious water is also usable. In addition to particle size and water content, various other criteria can be used to characterize the copper-aluminum catalyst precursors of this invention. BET surface area of the precursors can be as low as about 0.1 m2/g. BET surface areas greater than about 10 m2/g are preferred and those greater than about 15 m2/g are particularly preferred.

Trace impurities and extraneous matter may be present in the nanosized copper catalyst precursors depending on the method and conditions of their preparation. Thus, trace amounts of barium, calcium, chromium, iron, lead, magnesium, manganese, nickel, phosphorus, sodium, tin and zinc may be present in the commercial Cu—Al alloys.

Zinc content of the copper catalyst precursor is desirably less than about 2500 parts per million, preferably less than about 1500 parts per million and more preferably less than about 750 parts per million. Based on the initial weight of silicon metal charged to the reactor, zinc content of the reaction slurry should ordinarily be less than about 100 parts per million, and preferably less than about 50 parts per million. The other trace element which can be contained in the catalyst precursor is lead (Pb). Its concentration in the slurry should ordinarily be less than about 50 parts per million and preferably less than ten parts per million.

The copper-aluminum catalyst precursors used in the Direct Synthesis process of this invention will be employed at a level which is effective to catalyze the reaction. Generally, an effective amount ranges from about 0.01 to about 5 parts by weight of catalyst precursor per 100 parts by weight of the silicon metal. The smaller particle size and higher surface area of the nanosized copper-aluminum catalyst precursors preferred for use in the instant invention afford higher dispersion of the actual catalytic phases on the silicon surface. Accordingly, usage of nanosized copper-aluminum catalyst precursors in amounts in the lower part of the broad range is unusually effective in initiating and sustaining selective synthesis of trialkoxysilanes. Thus, from about 0.05 to about 2 parts by weight of the nanosized copper-aluminum catalyst precursor per 100 parts by weight silicon metal is preferred and from about 0.08 to about 1 part by weight per 100 parts by weight silicon is especially preferred. Expressed in terms of parts by weight copper per 100 parts by weight silicon, an effective range is from about 0.008-4.5 parts copper, the preferred range is from about 0.03-1.8 parts copper and the more preferred range is from about 0.05-0.9 parts.

Combinations of Cu—Al with copper formate, copper chloride and/or copper hydroxide can also be used to activate silicon metal for the Direct Synthesis of alkoxysilanes. However, it has been determined that copper sources to be used as catalysts in the Direct Synthesis of trialkoxysilanes are desirably free or substantially free of chloride or other halide ions. In an embodiment, “substantially free” means that the copper source contains less than 100 ppm, preferably less than 50 ppm, of chloride or other halide ions. Halide ions can prove to be corrosive, and affect the choice of materials of construction of the reactor and vessels and piping. Moreover, their presence can adversely affect the downstream use of the reaction product. Thus, the use of chlorides and other halides should be avoided.

### Silicon

The silicon metal reactant used in the process of this invention can be any commercially available grade of silicon metal in particulate form. It may be produced by any of the methods in current practice, such as casting, water granulation, atomization and acid leaching. These methods are more fully described in Silicon for the Chemical Industry, (H. Oye, et al, Editors), vol. I (pp 39-52), vol. II (pp 55-80), vol. III (pp 33-56, 87-94), Tapir Publishers, Norwegian Institute of Technology, in U.S. Pat. Nos. 5,258,053, 5,015,751, 5,094,832, 5,128,116, 4,539,194, 3,809,548 and 4,539,194, and German Patents 3,403,091 and 3,343,406. Special types of chemical grade silicon containing controlled concentrations of alloying elements are also suitable, provided that copper is not one of the alloying elements and that the alloying elements are not deleterious to the rate, selectivity and stability of the trialkoxysilane Direct Synthesis process. Special silicon of this type is described in U.S. Pat. Nos. 5,059,343, 5,714,131, 5,334,738 and 5,973,177, and European Patent Applications 0494837 and 0893448.

A typical composition of commercial silicon metal useful in this invention, expressed in percent by weight, is Si˜98.5%, Fc<1%, Al˜0.05 to 0.7%, Ca˜0.001 to 0.1%; Pb<0.001%, Water<0.1%. Generally, smaller particle sizes are preferred for case of dispersion in the slurry, faster reaction and minimization of erosion in the reactor. Preferably, there are no particles larger than about 500 micrometers so that reactor erosion is minimized. Sieving of ground silicon metal to regulate particle size is optional. A particle size distribution wherein at least about 90 weight percent is between about 1-300 micrometers is preferred. Especially preferred is a distribution in which at least about 90 weight percent of the silicon metal particles is between about 20-200 micrometers.

### Alcohols

Alcohol reactants which are useful in the process of this invention are those of the formula ROH wherein R is an alkyl group containing from 1 to 6 carbon atoms, inclusive. Preferably R is an alkyl group containing from 1 to 3 carbon atoms inclusive. The more preferred alcohols are methanol and ethanol. While it is customary to use a single alcohol in the Direct Synthesis process, mixtures of two or more alcohols can also be used to prepare trialkoxysilanes with different alkoxy groups, or to facilitate the reaction of a less reactive alcohol. For example, up to about 5 weight percent methanol may be added to ethanol to improve the rate and stability of the Direct Synthesis of triethoxysilane. Alternatively, the reaction can be initiated with one alcohol and continued with another, or with a mixture. Thus, copper-activated silicon prepared with nanosized copper-aluminum catalyst precursors according to the instant invention can be reacted initially with methanol and later with ethanol. It is preferable that the alcohol be anhydrous. However, some water content, e.g., of up to about 0.1 weight percent, can usually be tolerated without significant loss of selectivity, reactivity and stability.

Generally, the Direct Synthesis process is carried out batchwise in a slurry and the alcohol fed into the slurry as a gas or liquid. Gaseous introduction is preferred. An induction period lasting from a few minutes up to about five hours may be observed. The initial alcohol feed rate is optionally controlled at a low level and increased following the induction period. Similarly, the alcohol feed rate is optionally reduced after about 70 weight percent silicon conversion to minimize the formation of tetraalkoxysilanes. Generally, once the reaction is running, the alcohol feed rate can be adjusted to provide the desired level of alcohol conversion. One skilled in the art can readily adjust the feed rate in a given reaction run by monitoring the product composition. If the feed rate is too high, the product stream will contain a larger proportion of tetraalkoxysilanes and unreacted alcohol.

### Reaction Solvent

Solvents for the slurry-phase Direct Synthesis process of trialkoxysilanes maintain the copper-activated silicon in a well-dispersed state and facilitates both mass transfer of the alcohol to catalytic sites and heat transfer between the reacting solids and the reactor. Solvents useful in the process of this invention are thermally stable compounds or mixtures that do not degrade under the activation and reaction conditions. Structurally, such solvents can be linear or branched paraffins, naphthenes, alkylated benzenes, aromatic ethers, polyaromatic hydrocarbons, and the like. In the latter case, the aromatic rings can be fused together as in naphthalene, phenanthrene, anthracene and fluorene derivatives. They can be joined by single carbon-carbon bonds as in biphenyl and terphenyl derivatives, or they can be joined by bridging alkyl groups as in the diphenylethanes and tetraphenylbutanes.

One class of preferred solvents is the high temperature stable organic solvents typically used as heat exchange media. Examples of heat exchange type solvents include THERMINOL® 59, THERMINOL® 60, THERMINOL® 66, DOWTHERM® HT, MARLOTHERM® S, MARLOTHERM® LH, JARYTHERM® BT06, diphenyl ether, diphenyl and terphenyl and their alkylated derivatives with normal boiling points higher than about 250° C.

THERMINOL® is an Eastman Chemical Company trade name for heat transfer fluids. THERMINOL® 59 is a mixture of alkyl-substituted aromatic compounds recommended for use between-45 to 315° C. THERMINOL® 60 is a mixture of polyaromatic compounds with an average molecular weight of 250. Its optimum temperature range is from −45° to 315° C. THERMINOL® 66 and DOWTHERM® HT are mixtures of hydrogenated terphenyls with an average molecular weight of 240. Maximum temperature limit is about 370° C. THERMINOL®59, THERMINOL® 66 and DOWTHERM® HT are preferred solvents of this invention.

DOWTHERM® fluids are produced by Dow Chemical Company.

MARLOTHERM® is an Eastman Chemical Company trade name for its heat transfer fluids. MARLOTHERM® S is a mixture of isomeric dibenzylbenzenes. MARLOTHERM® LH is a mixture of isomeric benzyl toluenes. Both can be used at temperatures up to about 350° C. Both are preferred solvents for the instant invention.

JARYTHERM® is the Arkema Chemicals Company trade name for its heat transfer fluids. JARYTHERM® BT06 is one such heat transfer fluid. It comprises a mixture of benzyltoluene isomers, dibenzyltoluene isomers and ditolylphenylmethane.

Suitable alkylated benzenes for the practice of the instant Direct Synthesis process are dodecylbenzene, tridecylbenzene, tetradecylbenzene and their mixtures such as are sold by Vista Chemical Company under the trade name NALKYLENE®, and by Condea Augusta s.p.a. under the trade names ISORCHEM® and SIRENE®. NALKYLENE® 550BL, NALKYLENE® 550L, NALKYLENE® 500, NALKYLENE® 501, NALKYLENE® 600L and NALKYLENE® V-7050 are particularly preferred reaction solvents for use with the nanosized copper-aluminum precursors. The alkylated benzene solvents typically afford better reaction stability and selectivity to the trialkoxysilanes when used with nanosized catalyst precursors at temperatures between 180-220° C.

Naphthenes are cycloparaffins. They are components of white mineral oils, petroleum distillates and some fuels. White mineral oils and petroleum distillates also contain normal and branched paraffins (see A. Debska-Chwaja, et al., Soap, Cosmetics and Chemical Specialties, (November 1994), pp 48-52; ibid., (March 1995) pp 64-70). Suitable examples of commercial products containing naphthenes and paraffins and useful as reaction solvents for this invention are the white mineral oils, CARNATION 70, KAYDOL, LP-100 and LP-350, and the petroleum distillates, PD-23, PD-25 and PD-28, all of which are sold by Crompton Corporation under the WITCO trade name. Other examples of naphthenes useful as reaction solvents are butylcyclohexane, decahydro-naphthalene, perhydroanthracene, perhydrophenanthrene, perhydrofluorene and their alkylated derivatives, bicyclohexyl, perhydroterphenyl, perhydrobinaphthyl and their alkylated derivatives.

Mixtures of alkylated benzenes, naphthenes and normal and branched paraffins with polyaromatic hydrocarbons are also useful as reaction solvents for the instant invention.

Used solvents can be treated with boric acid and borates as described in U.S. Pat. No. 5,166,384, or formic acid as disclosed in U.S. Pat. No. 6,090,965, or by thermal hydrolysis as disclosed in U.S. Pat. No. 6,166,237 and reused in subsequent trialkoxysilane Direct Synthesis reactions.

Silicon metal, copper-aluminum catalyst precursor, promoter and solvent can be added together in the reactor in any order. However, it is preferable to add the solids to the solvent to enable facile stirring. The solvent should be present in an amount sufficient to disperse the solid and gaseous reactants homogeneously. Generally, reactions are initiated with solvent and solids in a gravimetric ratio between about 1:2 and about 4:1, preferably about 1:1 to about 2:1. However, as the silicon metal is consumed during batchwise Direct Synthesis, the solvent-to-solids ratio will increase. The ratio can be maintained within narrow limits of the preferred range for continuous reactions.

### Copper-Silicon Activation Conditions

Activation is the process of incorporating catalyst (or precursor), and if desired, other auxiliary agents, into the silicon metal to make it reactive with the alcohol. Activation may be performed in the same reactor used for the Direct Synthesis or in a separate reactor. In the latter case, the activated silicon is typically and desirably transported to the synthesis reactor in an anhydrous, non-oxidizing atmosphere by known methods. Transportation of the activated silicon as a slurry in the reaction solvent is especially preferred.

Activation of copper catalyst precursors and silicon metal in a slurry reactor can generally be performed at about 20 to 400° C., preferably between about 150 to 300° C., with mixtures containing from about 0.01 to about 50 weight percent copper relative to silicon.

A phosphorus-containing promoter is optionally present during the activation. In one embodiment of the invention, the agitated slurry is heated to about 200 to 300° C. in an inert gas (for example, nitrogen or argon) atmosphere for about 0.01 to 24 hours prior to the injection of the alcohol reactant. Time and temperature must be sufficient to bring about effective copper silicon activation and avoid significant loss of trialkoxysilane selectivity, and/or formation of hydrocarbons and water during the Direct Synthesis. It is not necessary that all of the silicon metal be present during the activation step. For example, a portion of the silicon to be used and all of the copper-aluminum catalyst precursor can be activated in the reaction solvent and the remaining silicon metal added thereafter.

Alternatively, alcohol, optionally admixed with inert gas, is introduced into the agitated slurry of copper-aluminum catalyst precursor, promoter, silicon metal and reaction solvent during heating. Reaction ensues beyond a minimum temperature, typically greater than 180° C., at atmospheric pressure. Preferably, alcohol vapor is introduced into an agitated slurry after the temperature is greater than or equal to about 180° C.

### Reaction Conditions

Designs, descriptions and operational considerations pertinent to three phase reactors are contained in the following monograph, articles and patents:
A. Ramachandran and R. V. Chaudhari, Three Phase Catalytic Reactors, Gordon and Breach Science Publishers, NY, 1983.
N. Gartsman, et al., International Chemical Engineering, vol. 17 (1977) pp 697-702.
H. Ying, et al., Industrial & Engineering Chemistry, Process Design & Development, vol. 19 (1980) pp 635-638.
N. Satterfield, et al., Chemical Engineering Science, vol. 35 (1980) pp 195-202.
M. Boxall, et al., Journal of Metals, (August 1984) pp 58-61
U.S. Pat. No. 4,328,175

Reactors may be operated in a batchwise, semi-continuous or continuous mode. In batchwise operation, a single addition of silicon metal and copper catalyst precursor is made to the reactor at the outset and alcohol is added continuously, or intermittently, until the silicon metal is fully reacted, or reacted to a desired degree of conversion.

In continuous operation, as compared to batch operation, silicon metal and copper catalyst precursor are added to the reactor both initially and subsequently to maintain the solids content of the slurry within a selected range. The alcohol is added continuously. It is to be understood that during continuous operation, the alcohol feed may optionally be interrupted for a brief period during the silicon metal addition while maintaining the continuous mode of operation.

The batchwise mode is illustrated in U.S. Pat. No. 4,727,173 and the continuous mode in U.S. Pat. No. 5,084,590. Semi-continuous (also called multi-batching) operation occurs when additional silicon metal, copper-aluminum catalyst precursor and phosphate promoters are added to the reactor after silicon conversion has attained a desired degree of conversion, and the alcohol is added continuously, or intermittently, until the silicon conversion has attained the desired degree of conversion in each instance.

Many such additions of silicon metal can be made without further addition of solvent. Typically, at least three and as many as ten additions of solids can be made before condensed silicates, gels and resins form in the slurry and increase its viscosity. Increased viscosity leads to a reduction in mass transfer of the alcohol to the copper-activated silicon surfaces and decreased reaction rate.

Use of Cu—Al as the source of catalytic copper according to the present invention is accompanied by reduced formation of condensed silicates (also called Heavies) and reduced formation of gels and resins. Heavies are soluble in the crude reaction product and are quantified with gas chromatography or NMR. Gels and resins are observable on the walls and impellers of the reactor.

In its preferred embodiment, the Direct Synthesis of alkoxysilanes is conducted in a continuously agitated slurry reactor containing thermally stable solvent, silicon metal, copper-aluminum catalyst precursor, phosphate-containing promoter and foam control agents in contact with alcohol vapor. The number and type of impellers are selected to afford effective solids suspension, gas dispersion and mass transfer of alcohol to the copper-activated silicon. The reactor may have a single nozzle or multiple nozzles for the introduction of gaseous alcohol. A mechanism of continuous or intermittent addition of promoter, copper-aluminum catalyst precursor-silicon mixture, or of silicon metal, should also be provided. A mechanism for continuous removal and recovery of the volatile reaction products and unreacted alcohol are also desirably provided. Separation and purification of the trialkoxysilane products are optimally performed in the manner disclosed in U.S. Pat. No. 4,761,492 or 4,999,446.

When the initial loading of silicon metal and copper-aluminum catalyst precursor is activated according to the method of the invention, continuous slurry phase Direct Synthesis of alkoxysilanes is advantageously continued by adding only silicon, or silicon containing less copper-aluminum catalyst and phosphate-containing promoter than that initially added. In this way, the copper concentration of the slurry is controlled to minimize the transformation of the alcohol to hydrocarbons and water (Equations 3, 4, 5 and 10 above). Disadvantages caused by water have been recited hereinabove.

The reaction is generally conducted at temperatures above about 150° C., but below such a temperature as would degrade or decompose the reactants, promoter, solvents or desired products. Preferably, the reaction temperature is maintained in a range from about 200° C. to about 280° C. The reaction of methanol with the copper-activated silicon of the present invention is preferably conducted at about 220 to 270° C., and most preferably at about 230 to 260° C. The reaction with ethanol is preferably operated at about 200-240° C., and most preferably at about 205 to 230° C. The pressure at which the reaction is conducted can be varied from sub-atmospheric to super-atmospheric. Atmospheric pressure is generally employed in the reaction of methanol or ethanol with copper-activated silicon. Pressures in the range of about 1 to 5 atmospheres are advantageous to increase reaction rate in the Direct Synthesis process herein.

Preferably, the contents of the reaction mixture are agitated to maintain a well-mixed slurry of the copper-activated silicon particles, promoter and gaseous alcohol in the solvent. The term agitation herein encompasses any mechanism for imparting movement to the slurry, such as stirring or flowing the slurry with turbulence, or bubbling a gas into the slurry. The exit line carrying the gaseous reaction mixture from the reactor is preferably well insulated to help insure that the trialkoxysilane does not reflux. Refluxing can encourage the consecutive reaction of the trialkoxysilane with the alcohol, resulting in loss of the desired trialkoxysilane product by the formation of the tetraalkoxysilane.

The presence of gaseous alcohol, hydrogen gas and other gases in the reactor can occasionally lead to foaming. This is undesirable, since it can result in loss of solvent, promoter and copper-activated silicon from the reactor. Therefore, it can be useful to control foam produced during the reaction. U.S. Pat. No. 5,783,720 teaches that the addition of foam control agents to the reaction slurry, preferably silicon-containing foam control agents such as Momentive Performance Materials SAG® 1000, SAG® 100, SAG® 47 and FF-170, Wacker-Chemie OEL AF 98/300 and Dow Corning FS 1265, will negate or control this problem. SAG® 1000, SAG® 100 and SAG® 47 are foam control compositions, comprising polydimethylsilicones and silica. FS 1265, FF-170 and OEL AF 98/300 contain fluorinated silicones, for example, poly(trifluoropropylmethyl-siloxanes). The foam control agent must be durable such that a single addition at the outset of a batch reaction is sufficient to avoid or mitigate foam formation until all of the silicon metal has been consumed. Effective use levels of foam control agents span 0.000001-5 weight percent based on the total initial weight of the reaction slurry. Higher levels can occasionally lead to reduced reaction rates. Physical and mechanical methods of preventing or controlling foam formation can also be employed. These include rakes, ultrasonic devices, and foam arrestors.

At substantially constant temperature, the reaction rate depends significantly on the surface area and particle size of the silicon metal and copper catalyst precursor and on the feed rate of the alcohol. Higher reaction rates are obtained at higher surface areas, finer particle sizes, and higher alcohol feed rates. These parameters are selected so that a safe, economically sustainable product output is realized without endangerment to people, property and the environment. Deactivation can be reduced or forestalled and stability sustained by reducing the alcohol flow rate during the course of a triethoxysilane Direct Synthesis. This flow rate control not only decreases the excess alcohol available for dehydrogenation and other side reactions, but also facilitates product separation in a stripping column downstream of the reactor.

High selectivity to trialkoxysilanes, high reaction rates and stable performance can be realized when copper catalyst precursors and phosphorus-containing promoters are used in practice of preferred embodiments of the invention. This is particularly so when trimethoxysilane is prepared by the Direct Synthesis process of the invention. Preferably, the copper catalyst precursor is a Cu—Al alloy and the promoter is copper orthophosphate or copper hydroxyphosphate. By the teachings of this invention, the trialkoxysilane/tetraalkoxysilane gravimetric ratio is at least 15, preferably greater than 17 and most preferably greater than 20. Simultaneously, silicon conversion is greater than 50 percent, preferably greater than 70 percent and most preferably greater than 85 percent before the reaction rate and/or selectivity to trialkoxysilane falls to unacceptable levels.

### EXAMPLES

The following Examples illustrate important features of preferred embodiments of the instant invention. These examples are not intended to limit the scope of the invention. Rather, they are presented to illustrate preferred embodiments of the invention and to facilitate the practice of the invention by those of ordinary skill in the art.

### Abbreviations and Units Used

Abbreviations used in the presentation of the data of the illustrative examples are the following:

TABLE 1
ABBREVIATIONS USED AND THEIR MEANINGS

| ABBREVI- | | ABBREVI- | |
|---|---|---|---|
| ATION | MEANING | ATION | MEANING |
| TMS | HSi(OCH₃)₃ | g | gram |
| TMOS | Si(OCH₃)₄ | kg | kilogram |
| MeOH | CH₃OH | L | liter |
| SEL | HSi(OR)₃/Si(OR)₄ | nm | nanometer |
| min | minute | μ | micron |
| % Si/hr | Percent silicon | m²/g | square meters |
| | converted per hour | | per gram |
| wt % | weight percent | rpm | revolutions |
| | | | per minute |
| TH59 | THERMINOL ® 59 | cm⁻¹ | Wavenumber |
| MLH | MARLOTHERM LH | | |
| ppm | Parts per million | Conv | Conversion |
| mL | Milliliter | | |

### Equipment Used

An 8 liter three-phase stainless steel slurry reactor was used for the illustrative Examples presented here. Four 90° spaced, 1.27 cm wide baffles were affixed to the wall of the reactor. Agitation was provided by two impellers attached to an axial shaft. An electric heating mantle controlled by a heater/temperature controller was used to heat the reactor. Valved connections were available at the top of the reactor for the attachment of stainless steel cylinders, which could be used for the injection of additives (under nitrogen pressure) into the reactor, or sampling the reactor contents.

Methanol or ethanol was supplied to the reactor via a calibrated laboratory pump. The vaporized alcohol inlet line entered through the top of the reactor. It was heat traced and controlled at 120° C. to prevent condensation of the vapor. Alcohol vapor was injected to the reactor below the level of the turbine.

Reaction products and unreacted alcohol exited the reactor through a packed tube, which served as entrainment separator and partial distillation column to remove solvent and higher boiling silicates from the product stream. The packing was Teflon balls supported on stainless steel mesh. Thermocouples were distributed along the length of the tube to record temperatures and indicate foaming. The lowest thermocouple was flush with the top of the reactor. Foaming was controlled by the use of FF170, FS 1265, AF 98/300, SAG® 47 and SAG® 100. Flexible stainless steel tubing connected the outlet of the entrainment separator/partial distillation column to the refrigerated heat exchanger, which was similarly attached to a four-way valve regulating sampling and crude product flow to the distillation columns.

Two ten plate Oldershaw distillation columns served to separate the liquid reaction products and unreacted alcohol from the gases. Effluent from the reactor was admitted into the top trays of the lower column. A magnetically controlled reflux condenser and distillation head with thermocouple capped the upper column. The reflux condenser and another condenser downstream were cooled to −25° C. Uncondensed gases exited the condenser through a vapor lock bubbler into the hood. Wider tubing was employed downstream of the bubbler to avoid backpressure. Effluent gas flow was diluted with nitrogen prior to its discharge into the laboratory hood. A thermocouple was located in the second opening of the three-neck flask and the intake to an FMI laboratory pump in the other. The pump was used to transfer liquid product from the flask to storage bottles. All glass containers used to store or sample trimethoxysilane and triethoxysilane were washed with dilute HCl, rinsed thoroughly with methanol (or ethanol) and oven dried at 110° C. prior to use.

Gas chromatographic analysis of the reaction product was performed as described below.

### General Copper Silicon Activation and Reaction Procedure

The reactor was charged with solvent, silicon metal, copper-aluminum catalyst precursor and foam control agent and then sealed. The initial solvent to silicon weight ratio was typically 2:1. The slurry was agitated at 670-900 rpm and nitrogen was introduced during heating to the desired reaction temperature. Simultaneously, the alcohol vaporizer and feed inlet were heated to 150-170° C. and the refrigerant circulated through the reflux condenser was cooled to ˜−25° C. Alcohol flow to the reactor was initiated when all the set temperatures were attained. Nitrogen flow was reduced to ˜50 ml/min during the reaction.

Once the alcohol flow was underway, sampling and analysis of the vent gas stream for hydrogen were done every 10-30 minutes until a stable composition was established. That indicated the end of the induction period. Thereafter, gas sampling was done every 30 minutes to monitor hydrogen and other uncondensed byproducts. During the course of the reaction, total vent gas flow was used as an approximate measure of the reaction rate according to the stoichiometry of equation (1).

Samples were collected in previously acid washed, alcohol rinsed, oven-dried containers attached at the sampling valve for 2-5 minutes every half hour. The containers were cooled in dry-ice during sample collection. Samples were weighed and analyzed by gas chromatography. The bulk of the liquid product was condensed in the flask, which served as the reboiler, and transferred to storage. All of these data were used to calculate the temporal composition of the product stream, its selectivity to trialkoxysilane, the reaction rate and overall silicon conversion. Reactions were generally terminated after ˜ 50-70% of the silicon charged to the reactor had been reacted and while still in the steady-state region. The reactor was then cooled to <50° C. before it was opened for additional silicon, copper-aluminum alloy and promoter (copper orthophosphate or copper hydroxyphosphate) to be charged. Three or four raw material charges were typically made in these multibatch experiments. In some cases, terminations were made at lower and higher silicon conversions depending on the objective of the experiment and time constraints. Residual solids from the reaction were sometimes recovered and weighed to calculate silicon conversion. In most cases, silicon conversion was determined from the compositions and weights of the samples collected.

Gas samples were analyzed for hydrogen, nitrogen and hydrocarbon (e.g. methane, ethane) content with a gas chromatograph. Gas chromatography-mass spectrometry was used to analyze for dimethyl ether. Liquid samples containing alkoxysilanes were analyzed on a gas chromatograph and thermal conductivity detector.

### Materials Used

Technical grade silicon metal samples (Si-1, Si-2 and Si-3) utilized in the experiments of the illustrative Examples are identified in Tables 2-4 along with relevant analytical data. Note that the Al concentrations were all less than 0.3 wt %. Particles in the size range, 45-300 micrometers, accounted for approximately 70 weight percent of all three samples. MARLOTHERM® LH was the only solvent used. FF170 (Momentive), FS 1265 (Dow Corning) and Wacker-Chemie OEL AF 98/300 were the foam control agents. Methanol was ACS grade (>99.9 wt %) with water content <0.1 wt %.

Copper-aluminum alloy was obtained from Yamaishi Metal Co. Ltd. Its composition was nominally 60 wt % Cu and 40 wt % Al. Table 5 shows the particle size distribution. Almost 84 wt % was smaller than 45 microns. It was ground and sieved further to obtain particles less than 38 microns and less than 20 microns for some experiments.

Copper orthophosphate or copper hydroxyphosphate was used as the promoter for the Direct Synthesis of trimethoxysilane as taught in U.S. Pat. No. 7,652,164.

TABLE 2
TRACE ELEMENT COMPOSITION OF
Si-1 USED IN THE EXAMPLES

| ELEMENT | VALUE |
|---|---|
| Al, ppm | 1949 |
| Ba, ppm | <1 |
| Ca, ppm | 460 |
| Cr, ppm | 17 |
| Cu, ppm | 42 |
| Fe, wt % | 2459 |
| Mn, ppm | 81 |
| Ni, ppm | 27 |
| P, ppm | 25 |
| Pb, ppm | 3 |
| Sn, ppm | <1 |
| Ti, ppm | 202 |
| V, ppm | 20 |
| Zn, ppm | 16 |

TABLE 3
TRACE ELEMENT COMPOSITION OF
Si-2 USED IN THE EXAMPLES

| ELEMENT | VALUE |
|---|---|
| Al, ppm | 1629 |
| Ba, ppm | <1 |
| Ca, ppm | 745 |
| Cr, ppm | 12 |
| Cu, ppm | 27 |
| Fe, ppm | 3622 |
| Mn, ppm | 82 |
| Ni, ppm | 20 |
| P, ppm | 17 |
| Pb, ppm | 3 |
| Sn, ppm | <1 |
| Ti, ppm | 194 |
| V, ppm | 17 |
| Zn, ppm | 8 |

TABLE 4
TRACE ELEMENT COMPOSITION OF
Si-3 USED IN THE EXAMPLES

| ELEMENT | VALUE |
|---|---|
| Al, wt % | 0.2 |
| Ba, ppm | 13.4 |
| Ca, ppm | 517 |
| Cr, ppm | 28.6 |
| Cu, ppm | 19.5 |
| Fe, wt % | 0.39 |
| Mg, ppm | 23.9 |
| Mn, ppm | 125 |
| Ni, ppm | <10 |
| P, ppm | 25 |
| Pb, ppm | <10 |
| Sn, ppm | <10 |
| Ti, ppm | 312 |
| V, ppm | 20.5 |
| Zn, ppm | 6.6 |
| Zr, ppm | 100 |

TABLE 5
PARTICLE SIZE DISTRIBUTION
OF COPPER-ALUMINUM ALLOY

| PARTICLE | WEIGHT | STANDARD |
|---|---|---|
| SIZE, μm | PERCENT | DEVIATION, ± % |
| +75 | 0.3 | 0.5 |
| +63 | 3.5 | 1.8 |
| +45 | 12.4 | 3.7 |
| −45 | 83.7 | 5.0 |

### Examples 1 and 2

Examples 1 and 2 illustrate the use of copper-aluminum alloy containing 60 wt % Cu and 40 wt % Al, and with the particle size distribution shown in Table 5, as the copper source in the multi-batch Direct Synthesis of trimethoxysilane with two different silicon samples, Si-2 and Si-1. The copper concentration was 0.31 wt % and the aluminum 0.21 wt % based on weight of silicon charged.

Reactions were done at 250° C. and 650 rpm in the 8 liter reactor described hereinabove following the general procedure also described above. The quantities of materials used and the product compositions are summarized in Tables 6-9. Three silicon plus Cu—Al and phosphate promoter charges were made in Example 1 and four in Example 2. Marlotherm® LH was charged initially (Examples 1A and 2A) and no makeup Marlotherm® LH was required when additional solids were added in the subsequent reactions. Make-up quantities of silicon, Cu—Al and copper orthophosphate promoter in Examples 1B, 1C, 2B, 2C and 2D were based on weight of silicon converted in the previous reaction.

TABLE 6
RAW MATERIALS USED IN THE REACTIONS
OF EXAMPLE 1 (0.31 wt % Cu)

| | EXAMPLE | EXAMPLE | EXAMPLE |
|---|---|---|---|
| RAW MATERIAL | 1A | 1B | 1C |
| MARLOTHERM ® LH, g | 3,500 | None added | None added |
| Silicon, Si-2, g | 1,750 | 875 | 1225 |
| Copper-Aluminum, g | 9.0 | 4.5 | 6.3 |
| Copper Phosphate, g | 1.0 | 1.0 | 1.0 |
| FF170, g | 1.0 | None added | 1.0 |
| Methanol, g/min | 9.2 | 9.2 | 9.2 |

TABLE 7
DATA FOR MULTIBATCH EXPERIMENT
OF EXAMPLES 1A-1C

| PARAMETER | EXAMPLE 1A | EXAMPLE 1B | EXAMPLE 1C |
|---|---|---|---|
| Si Conversion, % | 43.78 | 68.15 | 68.93 |
| Average Selectivity | 31.07 | 32.12 | 29.73 |
| Average Rate, % Si/h | 4.62 | 7.16 | 7.26 |
| MDMS, wt % | 0.78 | 1.23 | 0.98 |
| TMS, wt % | 95.78 | 95.20 | 95.18 |
| MTMS, wt % | 0.07 | 0.14 | 0.11 |
| TMOS, wt % | 3.08 | 2.96 | 3.20 |
| HVS, % | 0.29 | 0.47 | 0.52 |
| Crude Product, g | 3354.79 | 5222.73 | 5288.20 |

TABLE 8
RAW MATERIALS USED IN THE REACTIONS
OF EXAMPLE 2 (0.31 wt % Cu)

| RAW MATERIAL | EX 2A | EX 2B | EX 2C | EX 2D |
|---|---|---|---|---|
| MARLOTHERM ® LH, g | 3500 | None | None | None |
| | | Added | Added | Added |
| Silicon, Si-1, g | 1750 | 1137.5 | 1137.5 | 1137.5 |
| Copper-Aluminum, g | 9.0 | 9.0 | 9.0 | 9.0 |
| Copper Phosphate, g | 1.0 | 1.0 | 1.0 | 1.0 |
| FF 170, g | 1.0 | None | None | None |
| Methanol, g/min | 9.2 | 9.2 | 9.2 | 9.2 |

TABLE 9
DATA FOR MULTIBATCH EXPERIMENT
OF EXAMPLES 2A-2D

| PARAMETER | EX 2A | EX 2B | EX 2C | EX 2D |
|---|---|---|---|---|
| Si Conv, % | 62.03 | 63.62 | 61.47 | 58.57 |
| Average | 33.28 | 36.31 | 39.82 | 39.88 |
| Selectivity | | | | |
| Average | 6.47 | 6.66 | 6.40 | 6.15 |
| Rate, % Si/h | | | | |
| MDMS, wt % | 5.08 | 4.09 | 2.28 | 2.06 |
| TMS, wt % | 91.29 | 92.57 | 94.44 | 94.69 |
| MTMS, wt % | 0.20 | 0.15 | 0.22 | 0.22 |
| TMOS, wt % | 2.74 | 2.55 | 2.37 | 2.37 |
| HVS, % | 0.69 | 0.64 | 0.70 | 0.66 |
| Crude Product, g | 4729.78 | 4855.22 | 4704.08 | 4482.70 |

The performance data for Examples 1 and 2 show that Cu—Al alloy afforded excellent activation of silicon containing less than 0.3 wt % Al from two different sources to produce 91-96 wt % TMS, Selectivity 29-40 and Rates 4-7% Si/h. Copper concentration provided by Cu—Al was 0.31 wt % based on the silicon charged at the start of each batch reaction. The induction period in the experiments of Examples 1A and 2A ended ˜11% silicon conversion and was <6% in Examples 1B-C and 2B-D. The concentration of soluble silicates (HVS) in the reaction product was less than 1 weight percent throughout the experiments of both examples indicating that water generation is significantly suppressed when Cu—Al is used. Visual inspection of the reactor during and after the experiments of Examples 1 and 2 showed no gels or resins on the walls, baffles or impellers.

### Example 3 (0.41% Cu) and 4 (0.51 wt % Cu)

Examples 3A-3D and 4A-4C illustrate the effects of increasing the usage of Cu—Al to catalyze the Direct Synthesis of trimethoxysilane with silicon containing less than 0.3 wt % aluminum. Quantities of raw materials used are shown in Tables 10 and 12. Reactions were done in the 8 liter reactor with Marlotherm® LH at 250° C. and 650 rpm as previously disclosed hereinabove. Experimental data are presented in Table 11 (Examples 3A-3D) and Table 13 (Examples 4A-4° C.). Copper concentration was 0.41 wt % Example 3 and 0.51 w1% in Example 4.

TABLE 10
RAW MATERIALS USED IN REACTIONS
OF EXAMPLE 3 (0.41 wt % Cu)

| RAW MATERIAL | EX 3A | EX 3B | EX 3C | EX 3D |
|---|---|---|---|---|
| MARLOTHERM ® LH, g | 3500 | None | None | None |
| | | Added | Added | Added |
| Silicon, Si-2, g | 1750 | 1050 | 1225 | 1137.5 |
| Copper-Aluminum, g | 12 | 7.2 | 8.4 | 7.8 |
| Copper Phosphate, g | 1 | 1 | 1 | 1 |
| FF170, g | 1.0 | None | None | 1.0 |
| | | added | added | |
| Methanol, g/min | 9.2 | 9.2 | 9.2 | 9.2 |

TABLE 11
DATA FOR MULTIBATCH EXPERIMENT
OF EXAMPLES 3A-3D

| PARAMETER | EX 3A | EX 3B | EX 3C | EX 3D |
|---|---|---|---|---|
| Si Conv, % | 55.75 | 65.70 | 64.56 | 61.78 |
| Average | 39.06 | 34.29 | 34.66 | 35.76 |
| Selectivity | | | | |
| Average | 5.87 | 7.12 | 6.81 | 6.45 |
| Rate, % Si/h | | | | |
| MDMS, wt % | 1.03 | 1.23 | 0.99 | 0.95 |
| TMS, wt % | 95.86 | 95.24 | 95.48 | 95.82 |
| MTMS, wt % | 0.08 | 0.12 | 0.09 | 0.08 |
| TMOS, wt % | 2.45 | 2.78 | 2.75 | 2.68 |
| HVS, % | 0.58 | 0.63 | 0.49 | 0.67 |
| Crude Product, g | 4271.55 | 5175.36 | 4952.79 | 4733.77 |

TABLE 12
RAW MATERIALS USED IN REACTIONS
OF EXAMPLE 4A-4C (0.51 wt % Cu)

| | EXAMPLE | EXAMPLE | EXAMPLE |
|---|---|---|---|
| RAW MATERIAL | 4A | 4B | 4C |
| MARLOTHERM ® LH, g | 3,500 | None | None |
| | | added | added |
| Silicon, Si-2, g | 1,750 | 1050 | 1225 |
| Copper-Aluminum, g | 15.0 | 9.0 | 10.5 |
| Copper Phosphate, g | 1.0 | 1.0 | 1.0 |
| FF 170, g | 1.0 | None | 1.0 |
| | | added | |
| Methanol, g/min | 9.2 | 9.2 | 9.2 |

TABLE 13
DATA FOR MULTIBATCH EXPERIMENT
OF EXAMPLES 4A-4C

| PARAMETER | EXAMPLE 4A | EXAMPLE 4B | EXAMPLE 4C |
|---|---|---|---|
| Si Conversion, % | 58.68 | 67.33 | 68.04 |
| Average Selectivity | 36.29 | 31.96 | 28.46 |
| Average Rate, % Si/h | 6.71 | 7.07 | 6.70 |
| MDMS, wt % | 1.15 | 1.28 | 0.99 |
| TMS, wt % | 95.34 | 95.07 | 95.19 |
| MTMS, wt % | 0.09 | 0.12 | 0.03 |
| TMOS, wt % | 2.63 | 2.97 | 3.34 |
| HVS, % | 0.79 | 0.55 | 0.44 |
| Crude Product, g | 4501.65 | 5161.67 | 5218.69 |

Taken together, the results of Examples 1, 2 and 3 show that excellent crude product yields, reaction rates and selectivities were obtained at low (0.3-0.5 wt %) copper concentrations. The reactor walls, impellers and baffles remained shiny and free of silicate gels and resins. HVS were also less than 1 weight percent and indicative of low water generation when Cu—Al is the source of catalytic copper in the Direct Synthesis.

### Example 5

Example 5 illustrates the Direct Synthesis of trimethoxysilane with silicon metal sample Si-3 and Cu—Al<38 micron particle size distribution. The as-received material described in Table 4 was sieved to obtain two fractions, particles <38 microns and <20 microns. Reactions were done as described in the general procedure above. Four raw material charges were made. Copper concentration was 0.41 wt %. Quantities of raw materials used are shown in Table 14. Performance data are in Table 15.

TABLE 14
RAW MATERIALS USED IN EXAMPLE 5A-5D
WITH Cu—Al < 38 MICRONS

| RAW MATERIAL | EX 5A | EX 5B | EX 5C | EX 5D |
|---|---|---|---|---|
| MARLOTHERM ® LH, g | 3500 | None | None | None |
| | | Added | Added | Added |
| Silicon, Si-3, g | 1750 | 1000 | 1050 | 1050 |
| Copper-Aluminum, g | 12 | 12 | 7.2 | 7.8 |
| Copper Phosphate, g | 1 | 1 | 1 | 1 |
| FF170, g | 1.0 | None | 1.0 | 1.0 |
| | | added | | |
| Methanol, g/min | 9.2 | 9.2 | 9.2 | 9.2 |

TABLE 15
DATA FOR MULTIBATCH EXPERIMENT OF EXAMPLES
5A-5D. Cu—Al < 38 μm

| PARAMETER | EX 5A | EX 5B | EX 5C | EX 5D |
|---|---|---|---|---|
| Si Conv, % | 49.61 | 56.46 | 60.0 | 58.67 |
| Average Selectivity | 34.22 | 29.04 | 23.53 | 17.57 |
| Average Rate, % Si/h | 5.36 | 6.03 | 6.41 | 6.16 |
| MDMS, wt % | 1.05 | 0.83 | 0.55 | 0.55 |
| TMS, wt % | 95.35 | 95.08 | 94.89 | 93.66 |
| MTMS, wt % | 0.06 | 0.08 | 0.06 | 0.12 |
| TMOS, wt % | 2.79 | 3.27 | 4.03 | 5.33 |
| HVS, % | 0.75 | 0.74 | 0.47 | 0.34 |
| Crude Product, g | 3806.47 | 4337.41 | 4302.59 | 4519.08 |

As has been already illustrated in Examples 1-4. Example 5 shows that silicon containing less than 0.3 wt % Al (<3000 ppm) yields excellent performance with a chloride-free source of catalytic copper (Cu—Al), which contained less than 50 wt % Al. These results are in contrast to the teachings of U.S. Pat. No. 5,362,897.

1. A process for the direct synthesis of alkoxysilanes, comprising:
a) forming a reaction slurry comprising: a thermally stable solvent, a silicon metal, a catalytically effective amount of a copper-aluminum alloy catalyst precursor, and optional catalyst promoter and an optional foam control agent;
(b) agitating and heating the reaction slurry to form a copper-activated silicon in-situ and feeding an alcohol into said reaction slurry to react with said copper activated-silicon to produce the alkoxysilanes.

2. The process of claim 1, further comprising (c) recovering the alkoxysilanes.

3. The process of claim 1, wherein the alkoxysilanes comprise at least one trialkoxysilane.

4. The process of claim 1, wherein the alkoxysilanes comprise at least one alkyldialkoxysilane.

5. The process of claim 1, wherein the reaction in the slurry is conducted batchwise, wherein a single addition of the silicon metal copper-aluminum alloy catalyst precursor and optional catalyst promoter and optional foam control agent is initially added to a reactor, and alcohol is added continuously or intermittently, until the silicon metal is reacted to a selected degree of conversion.

6. The process of claim 1, wherein the reaction in the slurry is conducted in continuous operation, wherein the silicon metal, the copper-aluminum alloy catalyst precursor and the optional catalyst promoter and optional foam control agent are added to a reactor initially and subsequently to maintain the solids content of the reaction slurry within a selected range, and wherein the alcohol is added continuously.

7. The process of claim 1, wherein the reaction conditions in the slurry are adjusted to maintain a tetraalkoxysilane byproduct content of about 6 weight percent or less.

8. The process of claim 1, wherein the alkoxysilanes produced in the slurry are adjusted to comprise about 70 weight percent or more trialkoxysilane.

9. The process of claim 1, wherein the catalyst promoter is present in the slurry during the course of the reaction and is selected from the group consisting of copper (I) cyanide, organonitriles, organic phosphates, and inorganic phosphates.

10. The process of claim 1, wherein the copper-aluminum alloy catalyst precursor comprises about 15 to 80 weight percent aluminum.

11. The process of claim 10, wherein the copper-aluminum alloy catalyst precursor comprises about 50 weight percent or less aluminum.

12. The process of claim 10, wherein the copper-aluminum catalyst precursor alloy comprises about 35 to about 45 weight percent aluminum.

13. The process of claim 10, wherein the copper-aluminum alloy catalyst precursor comprises about 15 to about 50 weight percent aluminum.

14. The process of claim 1, wherein the copper-aluminum alloy catalyst precursor is substantially free of halides.

15. The process of claim 1, wherein the copper-aluminum alloy catalyst precursor comprises particles with a size distribution ranging from about 0.1 to about 50 micrometers.

16. The process of claim 1, wherein the copper-aluminum catalyst precursor comprises particles with a size distribution of about 600 nanometers or less.

17. The process of claim 10, wherein the copper-aluminum catalyst precursors comprises particles with a size distribution in the range of from about 1 nanometer to about 100 nanometers.

18. The process of claim 1, wherein the copper-aluminum alloy catalyst precursors comprises particles with a size distribution in the range of from about 20 nanometers to about 60 nanometers.

19. The process of claim 1, wherein the alcohol is selected from one or more alcohols chosen from the formula ROH wherein R is an alkyl group containing from 1 to 6 carbon atoms.

20. The process of claim 1, wherein the thermally stable solvent is a high temperature heat transfer fluid.

21. The process of claim 1, wherein the heating of the reaction slurry is to a temperature from about 150 to 300° C.
